(19) United States
(12) Patent Application Publication
(10) Pub. No.: US 2005/0012967 A1
(43) Pub. Date: Jan. 20, 2005

(54) Image data processing apparatus and image data processing method

(76) Inventor: Yukihiro Okamura, Torrance, CA (US)

Correspondence Address: ANDERSON, KILL & OLICK, P.C., 1251 AVENUE OF THE AMERICAS, NEW YORK,, NY, 10020-1182, US

(21) Appl. No.: 10/855,170

(22) Filed: May 26, 2004

(30) Foreign Application Priority Data
Jun. 4, 2003 (JP) 2003-159355

(51) Int. Cl. H04N 1/40; H04N 1/46

(52) U.S. Cl. 358/474; 358/537

(57) ABSTRACT

An image data processing apparatus 20 for processing image data captured by at least one scanner from the back and front sides of a scanned medium (such as a check 2) to appropriately separate a media area where the scanned medium is present and a non-media area where the scanned medium is not present even when the edges of the scanned medium are printed a dark color, comprising an image area discriminator 22 for identifying a media area in which the scanned medium is present and a non-media area in which the scanned medium is not present from the image data on the front and back sides of the scanned medium; an area comparison unit 23 for comparing the size of the non-media area on the front side and the non-media area on the back side of the scanned medium respectively, with said comparison unit defining the smaller non-media area as a masking area; and a cropping control unit 24 for generating image data from the image data on the front side and/or from the image data on the back side thereof not containing image data in the masking area.

### BACKGROUND OF THE INVENTION 1. Field of Technology

The present invention relates to an image data processing apparatus and image data processing method for processing image data captured by a scanner.

2. Description of Related Art

In an image data reader (scanner) that images a check or other printed medium, the imaged area is determined according to the maximum size of the medium that can be (or is expected to be) handled. When a medium that is smaller than this maximum size is scanned, an image of the area where the scanned medium is not present is also captured, and unnecessary image data is therefore included in the captured image data. Saving or sending image data containing such unnecessary information is wasteful and inefficient, and it is therefore desirable to crop (remove) the unnecessary image information from the necessary image data being scanned.

This problem has conventionally been handled by the user (operator) defining the size of the scanned medium or scanning area for the image scanner before actually scanning the document in order to specifically acquire image data not containing unnecessary image information. Alternatively, the area where the scanned medium is present (the “media area”) and the area where the scanned medium is not present (the “non-media area”) can be identified in the captured image data, and image data in the non-media area can be deleted without deleting any image data containing valid image information (referred to hereafter as “valid image data”). The former method imposes a greater burden on the user (operator), and the latter method is therefore generally preferred.

This latter method can be achieved by lowering the reflectivity of the surface opposite the scanner (by making it black-colored, for example), and using the difference in the reflectivity (luminance/density) of the scanned medium and the surface to differentiate the media area from the non-media area.

A problem with this method of differentiating the media area and the non-media area based on the difference in reflectivity occurs when an edge (end) part of the scanned medium is printed with a dark color, thus resulting in low reflectivity. In this case the dark part of the scanned medium is wrongly recognized as part of the non-media area even though it is actually part of the media area, and the dark colored area is therefore deleted, resulting in a loss of necessary image data.

### SUMMARY OF THE INVENTION

Therefore, an object of the present invention is to provide an image data processing apparatus and image data processing method that eliminate or reduce as much as possible the likelihood of recognizing image data from the media area as if it were image data from a non-media area, and thus deleting valid image data, even in dark areas at the edges of scanned media.

To achieve this object, an image data processing apparatus according to the present invention processes images captured by at least one scanner from the back and front of a scanned medium by means of an area discrimination unit for identifying a media area in which the scanned medium is present and a non-media area in which the scanned medium is not present in the image data of the front and back sides of the scanned medium; an area comparison unit for comparing the size of the non-media area of the front and the non-media area of the back, and defining the smaller non-media area as a masking area; and a cropping control unit for generating image data not containing image data in the masking area from the front image data and/or back image data. In this case the image data processing apparatus also has an image data transmission unit for sending to an external unit image data from which image data in the masking area has been removed.

If the edge on one side of the scanned medium is printed with a dark color such that that part of the medium is recognized as a non-media area but the same edge on the other side of the medium is not printed with a dark color, the invention described herein can still appropriately separate the media area from the non-media area, and there is no danger of losing image data in the area printed with a dark color.

If this image data processing apparatus also has at least one scanner installed on both sides of a transportation path through which the scanned medium is conveyed, both sides of the medium can be imaged during a single pass through the transportation path, and the processing time can thereby be shortened.

Further preferably, the scanner captures image data of a conveyed scanned medium; and the area discrimination unit obtains a border position between the media area and non-media area for vertical columns in the image data, and discriminates the media area and non-media area on each side of the scanned medium based on these border positions. The vertical direction in this case is perpendicular to the transportation direction of the scanned medium.

The area discrimination unit in this case preferably obtains the border position for vertical columns sampled at a predefined interval. Processing time is shortened because the media area and non-media area are identified using periodically sampled column data, and the areas can therefore be identified in less time.

The present invention can also be expressed as an image data processing method or an image data processing program, such as a device driver or application program, for executing this image data processing method with the same benefits and effects as the image data processing apparatus of the invention.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is an internal schematic plan view of a check processing apparatus having an image data processing apparatus according to a preferred embodiment of the present invention;

FIG. 2 is a function block diagram of an image data processing apparatus according to the present invention;

FIG. 3 is a flow chart describing operation of the check processing apparatus;

FIG. 4 is a schematic image of image data captured by a scanner;

FIG. 5 is a flow chart of image data processing;

FIG. 6 is an example of a histogram generated after an averaging process in the image data process shown in FIG. 5; and

FIG. 7 is a flow chart of another embodiment of the invention for setting the border between the media area and non-media area.

### DESCRIPTION OF THE PREFERRED EMBODIMENTS

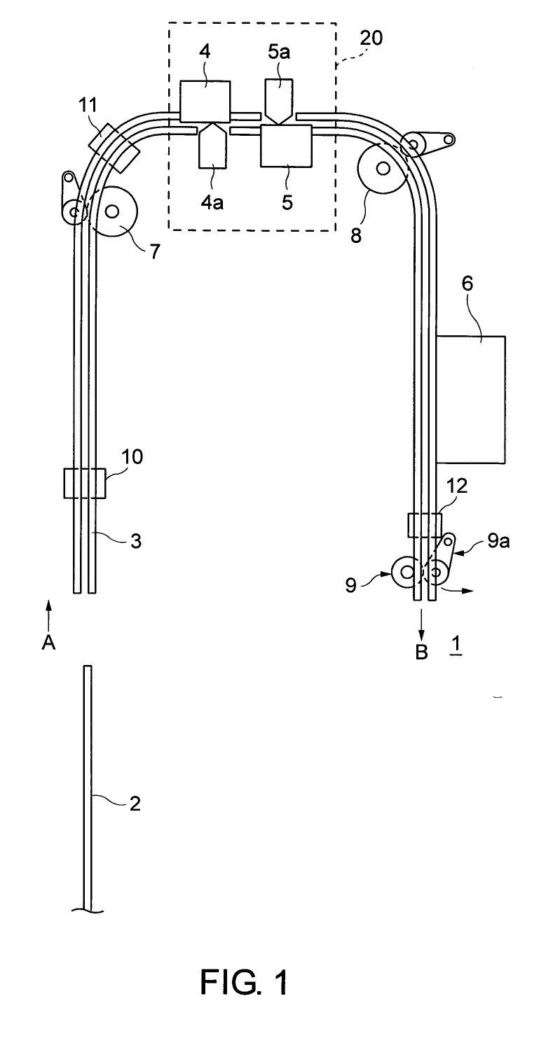

Preferred embodiments of the present invention are described below with reference to the accompanying figures. FIG. 1 is an internal schematic plan view of a check processing apparatus having an image data processing apparatus according to a preferred embodiment of the present invention. This check processing apparatus 1 images the front and back sides of a check 2 by means of scanners 4 and 5 while conveying the check 2 along a transportation path 3, and then prints an endorsement to the back of the check 2 using a print head 6.

The transportation path 3 is U-shaped. A check 2 inserted from the entrance on the left side in the direction of arrow A with the face (front) of the check facing the inside of the U-shape is then conveyed by first transportation rollers 7, second transportation rollers 8, and discharge rollers 9, and is discharged from the exit on the right side in FIG. 1 in the direction of arrow B. The back of the check 2 is imaged by scanner 4 as it passes thereby, and the front of the check 2 is imaged by the other scanner 5 as it passes that scanner.

Scanners 4 and 5 in this embodiment of the invention are contact image sensor (CIS) scanners capable of generating 256-level gray scale images. The scanners operate with the check 2 in contact with the scanner glass. The scanners 4, 5 therefore each have a pressure mechanism 4a, 5a, respectively, that presses the check 2 against the scanning surface of the scanner 4, 5. After the front and back of the check 2 are imaged by the scanners 4, 5, print head 6 is driven to print the date, amount, and other endorsement information to the back of the check 2. The print head 6 is an inkjet head in this embodiment of the invention.

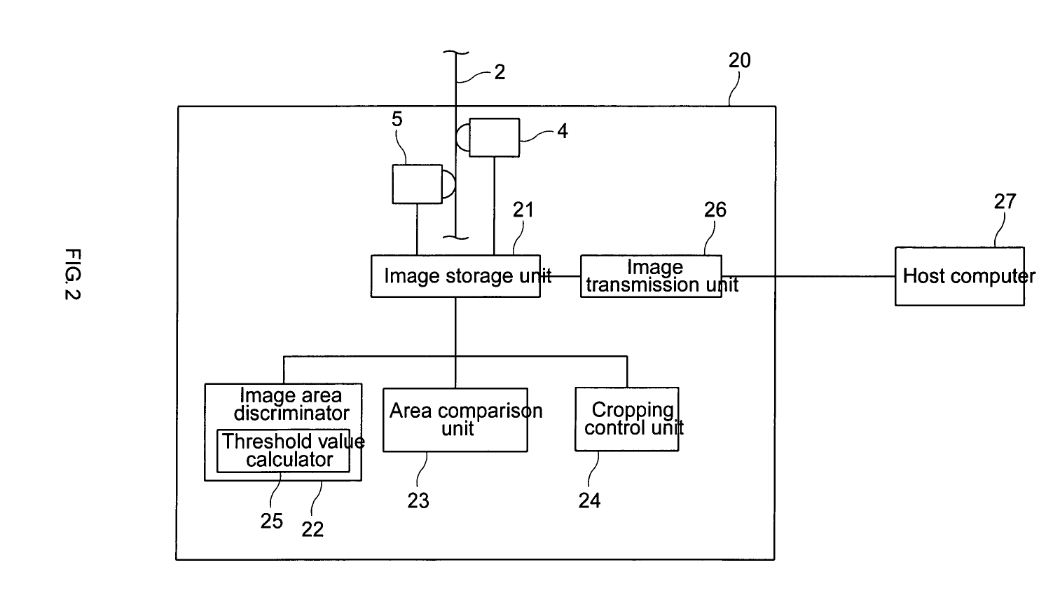

FIG. 2 is a function block diagram of the image data processing apparatus 20 in this check processing apparatus 1. As shown in FIG. 2, the image data processing apparatus 20 has an image storage unit 21 connected to the scanners 4, 5 for storing image data; an image area discriminator 22 having a threshold value calculator 25 for setting a threshold value for discriminating the media area and non-media area, and identifying the media area from the non-media area; an area comparison unit 23 for setting the masking area based on both the area identification result from the front and the area identification result from the back of the scanned medium; a cropping control unit 24 for cutting image data in the masking area from the captured image data; and an image transmission unit 26 for sending the cropped image data to the host computer 27 or other external unit.

The image storage unit 21, image area discriminator 22, area comparison unit 23, cropping control unit 24, and threshold value calculator 25 can be achieved with a CPU, ROM, and RAM, for example.

Image data from the back of the check 2 captured by scanner 4, and image data from the front of the check 2 captured by scanner 5, is stored in image storage unit 21. Using the image data stored in image storage unit 21, the threshold value calculator 25 calculates respective threshold values for image data on both the back and front of the check based on respective histograms of reflectivity values in the image data. Using these threshold values, the image area discriminator 22 then identifies the media area and non-media area in the image data for the back and front. The area comparison unit 23 then compares the size of the non-media areas identified for the back and front of the check by the image area discriminator 22, and sets the smaller non-media area as the masking area for the check 2. The cropping control unit 24 then deletes the image data in the masking areas from the image data for the back and front sides of the check stored in the image storage unit 21. The image transmission unit 26 then sends the image data from which image data in the non-media area has been removed to the host computer 27.

The image data that is cropped and saved from the front and back images captured by the scanners 4, 5 could be stored in the image storage unit 21. The image data that is not to be kept is used for defining the image data that is to be kept and the masking area containing the image data to be saved.

Whether image data from the front or the back, or both sides, of the scanned medium is to be cropped and saved from the total captured image data can also be defined using another control device or program. This embodiment of the invention is described as always saving image data from both sides of the medium.

The present invention thus identifies the media area and non-media area in the image data for the front and back images of the scanned medium, and sets the smaller of the two non-media areas as the masking area. As a result, even if a densely colored area existing at an edge (end) on one side prevents correctly identifying the media area on that side of the scanned medium, the likelihood of deleting meaningful image data from that side can be reduced. For example, if the scanned medium is a check 2 as in this embodiment of the invention, there is often a dark border around the edge of the check on the face, but there is no such border on the back. The media area can therefore be correctly identified from the back of the check, and removing image data in the desired media area of the check front can be effectively prevented.

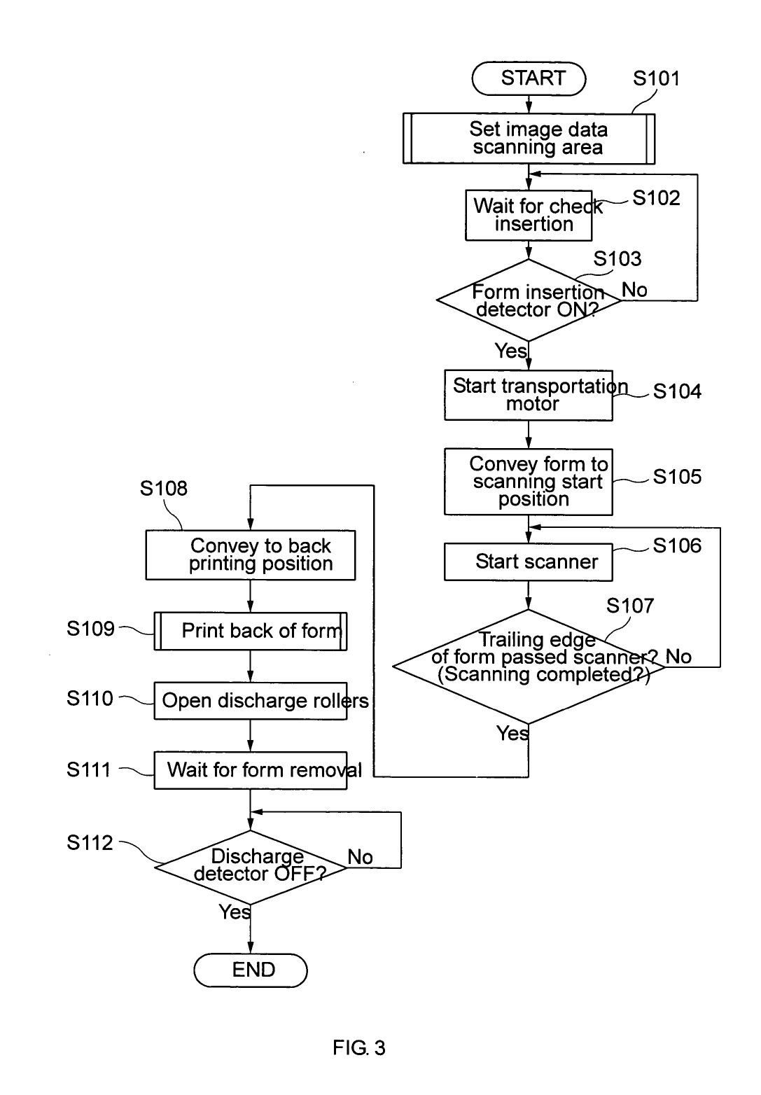

Operation of this check processing apparatus from insertion to discharge of the check 2 from the check processing apparatus 1 is described next below with reference to the flow chart in FIG. 3.

The size of the check 2 or the scanning area can be specified for the check processing apparatus 1 before inserting the check 2. If this size is not specified, the check processing apparatus 1 assumes that the maximum height and width (length in the transportation direction) dimensions of the check are equal to the scanning area of the scanners 4, 5 (step S101). The width (transportation length) of the check 2 can be determined from the transportation distance between the leading edge and the trailing edge of the check 2 detected by a paper detector top-of-form (TOF) detector 11. This detected length can then be used to set the maximum horizontal length of the area scanned by the scanners 4, 5. The maximum height of the scanning area can be determined by the pixel count of the scanners 4, 5.

When the operator then inserts a check 2 to the transportation path entrance of the transportation path 3 while the check processing apparatus 1 is waiting for a check 2 to be inserted (step S102), and the insertion detector 10 detects a check 2 (step S103), the transportation motor (not shown) is driven and the check 2 is conveyed by the first transportation rollers 7 (step S104). The check 2 is then sequentially gripped and conveyed by the first transportation rollers 7, second transportation rollers 8, and discharge rollers 9, and is then discharged from the exit.

After the leading edge of the check 2 is detected by the TOF detector 11, scanner 4 operation starts when the leading edge of the check 2 travels the length of the transportation path from the TOF detector 11 to the scanner 4, and scanner 5 operation starts when the check 2 is then conveyed the length of the transportation path from scanner 4 to scanner 5 (steps S105, S106). The front and back of the check 2 are imaged as the check 2 passes in contact with the scanners 4, 5, and the image data is stored to image storage unit 21.

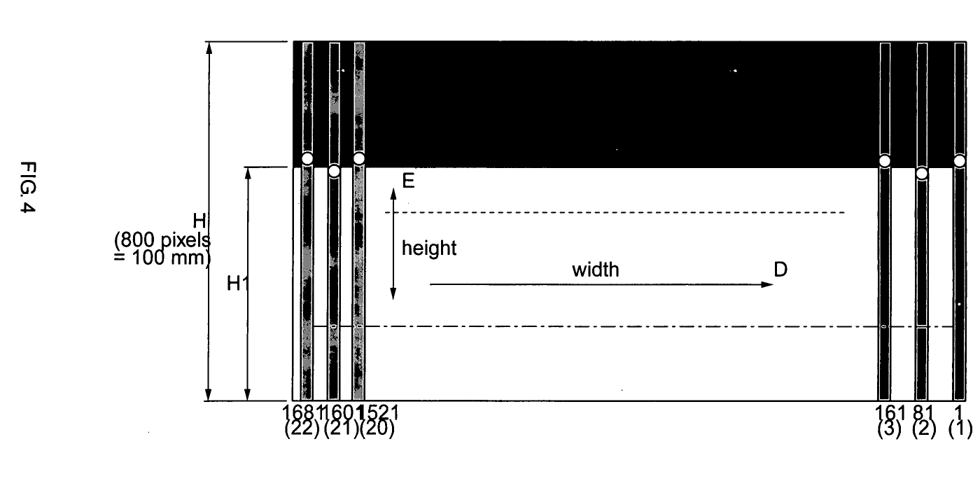

Referring to FIG. 4, as the check 2 travels in the direction of arrow D, the scanners 4, 5 scan from bottom to top columnwise in the direction of arrow E perpendicular to the direction of travel, and image the check. After the TOF detector 11 detects the trailing edge of the check 2, scanner 4 turns off (stops operating) when the check has travelled the length of the transportation path from the TOF detector 11 to the scanner 4. When the check has additionally travelled the length of the transportation path from scanner 4 to scanner 5, scanner 5 also turns off (step S107). Both front and back sides of the check 2 are thus imaged throughout the entire length of the check 2 by conveying the check 2 over the scanning surface of scanners 4, 5. Image data captured by the scanners 4, 5 is then processed by the image data processing apparatus 20 as further described below.

The check 2 is then conveyed to and stopped at the endorsement printing position (step S108), and the print head 6 is then driven to print the back of the check 2 (step S109). The discharge rollers 9 are driven intermittently while the print head 6 is driven to print the endorsement. When printing the check back is then completed, the discharge rollers 9 stop conveying the check 2, the arm 9a pivots counterclockwise to open the discharge rollers 9 (step S110), and the check 2 is thus released for removal (step S111). The discharge detector 12 can detect when the check 2 has been removed (step S112). This completes the image scanning process and printing process.

Note that the length of the check 2 can be measured from the number of steps the transportation motor is driven to convey the check 2 from when the TOF detector 11 detects that a form is present (detects the leading edge of the check 2) until it no longer detects the form (i.e., detects the trailing edge of the check 2). It is therefore possible to measure the horizontal length of the check 2 while the check 2 is being imaged by the scanners 4, 5, and use this measured length as the maximum horizontal length of the scanning area.

The form insertion detector 10, TOF detector 11, and form discharge detector 12 can be transmittance or reflective type photodetectors for contactlessly detecting the presence of the check 2 at specific positions along the transportation path 3.

FIG. 4 schematically shows image data captured by the scanners. The bottom of the image scanning area of the scanners 4, 5 (that is, the position of the lowest pixel of the scanners 4, 5) is at the bottom of the transportation path 3, and matches the bottom edge of the conveyed check 2. Scanner 4, 5 can read image data from this bottom pixel to the maximum height H of the scanning area (the position of the top pixel of the scanners 4, 5). In the example shown in FIG. 4 the height (length of the shortest side) of the check 2 is H1, which is less than maximum height H. The area above H1 is the non-media area and appears black. The area from the bottom edge to height H1 is the media area and appears white because the check 2 reflects light from the scanner. The reflectivity of the surface opposite the scanners 4, 5 is low, and the non-media area above height H1 therefore appears black.

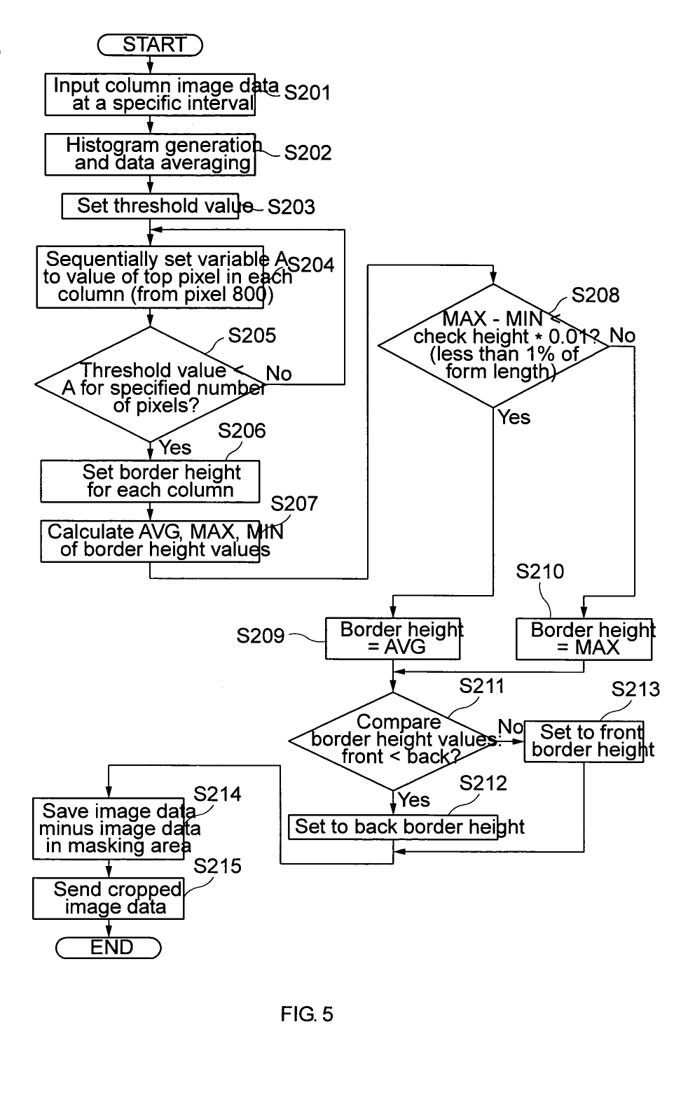

FIG. 5 is a flow chart of image processing for removing image data in the non-media area.

Threshold values are used to separate the media area and the non-media area. These threshold values can be determined from experience or experimentation, and can be entered to the image data processing apparatus 20 for use. The threshold values could, for example, be stored to flash memory or other nonvolatile storage device, or entered as parameters from a configuration command. In this embodiment of the invention, however, the threshold values are computed by the image data processing apparatus 20 based on image data captured by the scanners 4, 5.

The threshold value calculator 25 of the image data processing apparatus 20 calculates the threshold values from image data input from columns (shown in gray in FIG. 4) sampled from the image data captured by scanner 4 at a predefined interval in the transportation direction of the check 2 (step S201). In this embodiment of the invention one column of image data is sampled at 80 dot intervals, thus using as the image data samples columns 1, 81, 161, and so forth. In this embodiment of the invention 80 dots (80 pixels) in the transportation direction of the check 2 is equivalent to 10 mm. Therefore, if the check 2 is a personal check, the length is 152 mm, and 15 columns of image data are sampled from each side of the check. If the check 2 is a bank (corporate) check, the check length is 223 mm, and 22 columns of image data are sampled from each side of the check. Calculation time can be shortened by using sampled data instead of all of the captured image data to calculate the threshold values.

A histogram (frequency distribution) of the number of pixels of each reflectivity level (brightness level) is then generated from the sampled image data, and an averaging process is then applied to the histogram (step S202). Because there are 800 pixels (the number of pels in scanners 4, 5) in each column of image data, the total number of pixels in the image data used for generating the histogram is (15 columns×800 pixels/column=)12,000 pixels for a personal check (having 15 sampled image data columns), and is (22 columns×800 pixels/column=)17,600 pixels for a bank check (having 22 image data columns). The frequency distribution is expressed as follows.
fb(n), n=0,1, . . . , 255

The resulting frequency distribution is then averaged as follows.

$$\begin{matrix}fb ( n ) = {\sum }_{k = - 7}^{7} fb 1 ( n + k ) / 15 & 7 ⇐ n ⇐ 248 \\ fb ( n ) = 0 & n < 7 or n > 248\end{matrix}$$

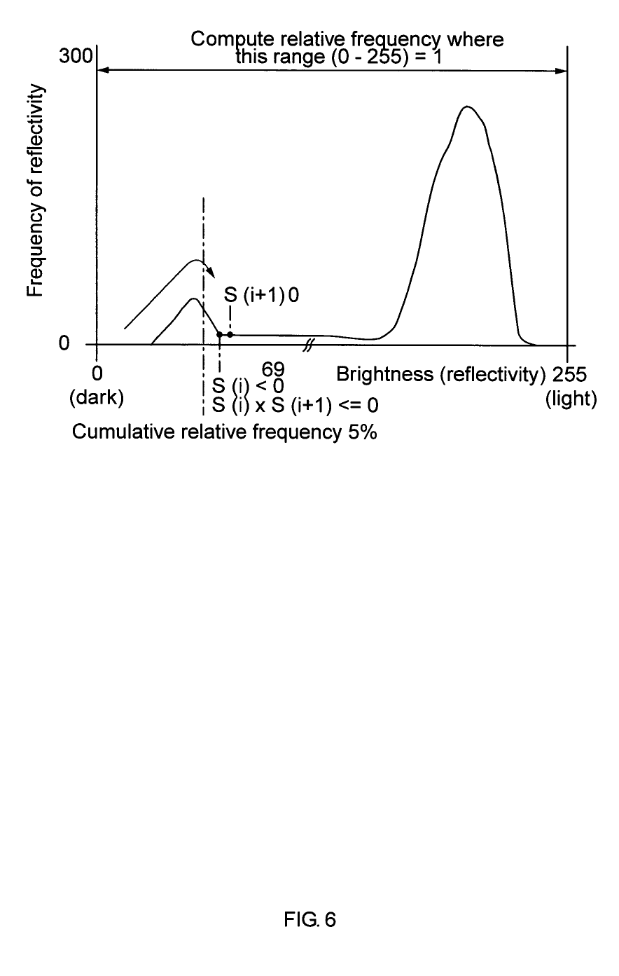

This averaging process calculates as the value of dot i, for example, the average of the values of the 15 dots including dot i and the 7 dots before and after dot i. This averaging process can remove noise components from the histogram, and can thereby extract the characteristic brightness value of each pixel. An example of a histogram resulting from this averaging process is shown in FIG. 6.

The threshold values for separating the media area from the non-media area are calculated next (step S203). In the histogram shown in FIG. 6, the first valley is used for the threshold value, and the slope of the histogram (curve) is therefore determined from the following equation where x is reflectivity (brightness) and y is the averaged frequency.

$$s ( i ) = \frac{{5 \sum }_{k = - 2}^{2} x ( i + k ) y ( i + k ) - ( {\sum }_{k = - 2}^{2} x ( i + k ) ) ( {\sum }_{k = - 2}^{2} y ( i + k ) )}{5 {\sum }_{k = - 2}^{2} {( x ( i + k ) )}^{2} - {( {\sum }_{k = - 2}^{2} x ( i + k ) )}^{2}} 9 ⇐ i ⇐ 246$$

Relative frequency r, which is the ratio of the pixel count of each reflectivity level n to the total number of pixels, is then calculated using the following equation.

$$r ( n ) = fb ( n ) / {\sum }_{k = 0}^{255} fb ( k ) \qquad 0 ⇐ n ⇐ 255$$

The point (reflectivity value) at which the cumulative relative frequency (accumulated to relative frequency r(n) from n=0) is 5% or more and conditions 1 to 3 below are true is set as the threshold value.
s(i)*s(i+1)<=0 0<=i<=N(N=69) Condition 1
s(i+1)>=0 0<=i<=N(N=69) Condition 2
s(i)<0 0<=i<=N(N=69) Condition 3

The point at which conditions 1 to 3 are true is the point (minimum) where slope s changes from negative to positive. The value of N is determined based on the reflectivity of the surface opposite the scanners 4, 5. When the scanners 4, 5 image this opposing surface, the reflectivity of the image data should be below a certain value, and this value is N.

The cumulative relative frequency is set to 5% or more because conditions 1 to 3 could be true when there are dark pixels caused by soiling, for example. The threshold value is therefore not set even if conditions 1 to 3 are true unless this cumulative relative frequency exceeds 5%.

It should be noted that this process for generating a histogram and calculating a threshold value is the same in concept as the method taught by us in previously filed U.S. patent application (first publication) 2003/0068077A1.

After the threshold value is determined, the image area discriminator 22 substitutes the image data value for the top pixel (pixel 800) of each scanner 4, 5 for each column (step S204). The image area discriminator 22 then compares the value of variable A with the threshold value. If the value of variable A is less than or equal to the threshold value (step S205: no), it substitutes the value of the next-lower pixel (that is, pixel 799 in this example) for variable A and repeats the comparison (steps S204, S205 repeat). If the number of pixels for which the value of A is greater than the threshold value exceeds a predefined limit (such as 10 pixels) (step S205 returns yes), the height of the pixel at which this limit was exceeded is set as the provisional height (that is, height (length of the short side) of check 2) of the border between the media area and non-media area for that column. This border calculation then proceeds to the next column.

If the number of columns in the check 2 being processed is 15, the border height is thus calculated for all 15 columns (i.e., 15 values are determined); if there are 22 columns, then 22 such height values are calculated (step S206). The open circles shown in FIG. 4 indicate the position of the border height calculated for each of the columns shown. The average, maximum (max) and minimum (min) of all of these border height values are then calculated (step S207).

If the difference between the maximum and minimum is less than 1% of the height of the check 2 (step S208 returns yes), it is known that the check 2 was not scanned at an angle (did not become skewed during transportation), and the average is therefore set as the border height of the check 2 being processed (step S209).

However, if the difference between the maximum and minimum is greater than or equal to 1% of the check 2 height (step S208 returns no), the check 2 may have been scanned at an angle (was skewed during transportation). To assure that no data is lost, the calculated maximum is therefore set as the border height of the check 2 being processed (step S210).

The process from step S201 to S210 is applied to the image data from both the front and back sides of the check 2 to determine the border height for each side.

The area comparison unit 23 of the image data processing apparatus 20 then compares the front and back border height positions calculated as described above, and sets the greater value, that is, the height of the higher border, as the height of the check 2 border, i.e., the length of the short side of the check.

More specifically, if the height of the border detected for the back of the check is greater than the height of the border detected at the front (step S211 returns yes), this back border height is set as the height of the check 2 (step S212). However, if the height of the border detected at the front of the check is greater than the height of the border detected at the back (step S211 returns no), this front border height is set as the height of the check 2 (step S213). The area above the top border thus defined is used as the masking area.

The cropping control unit 24 then stores the image data left after removing any image data in this masking area from the stored image data to image storage unit 21 (step S214). The desired image data left after cropping, or the image data of the side specified by the host for saving, is then sent by the image transmission unit 26 to the host computer 27 as required (such as in response to a request from the host computer 27) (step S215). The height of the check 2 used for cropping can also be sent to the host computer 27 as status information.

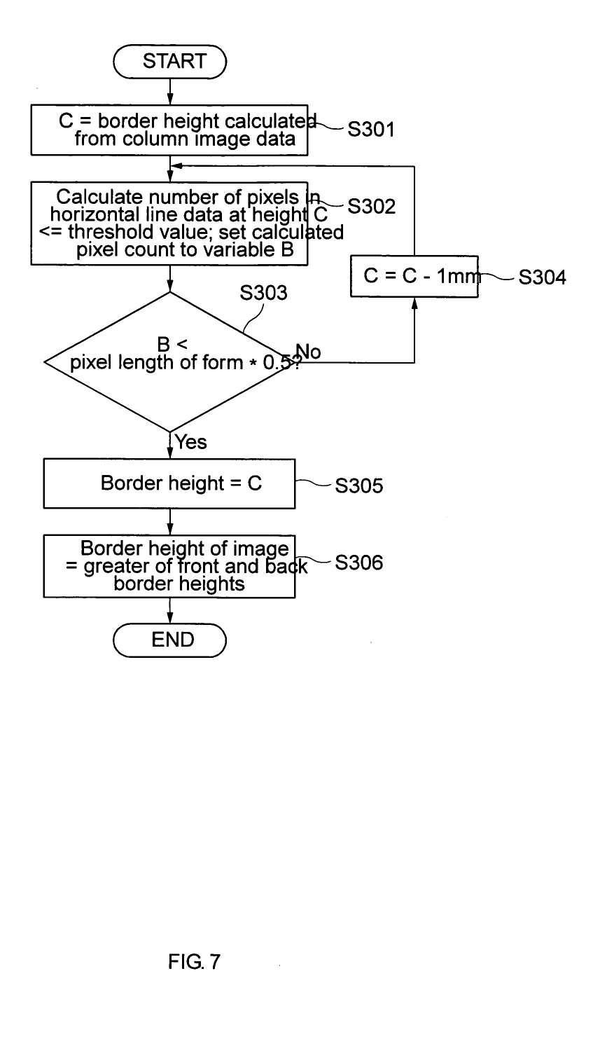

The masking area can also be set with consideration for the reflectivity of pixels in the horizontal rows (transportation direction) of the image data. This operation is described next with reference to the flow chart in FIG. 7. This process is executed after step S212 or S213 in FIG. 5.

The image area discriminator 22 inputs the border height determined from the process shown in FIG. 5 to variable C (step S301). It then compares the reflectivity of each pixel in the horizontal rows of the image data captured by scanners 4, 5 at border height C with the threshold value, and inputs the number of pixels equal to or less than the threshold value to variable B (step S302). If the number of pixels B below the threshold value is less than 50% of the total pixel count in the row (step S303 returns no), the current border height C is reduced 1 mm (equivalent to 1 mm) (step S304), and steps S302 and S303 are repeated at the new border height C. In other words, if the number of pixels B below the threshold value is 50% or more of the total pixel count in the row, the number of pixels in the non-media area in that row is more than half of the total pixel count, and that row is therefore determined to be in the non-media area. It should be noted that the height is reduced in 1 mm increments for faster processing because processing takes too long if the height is reduced in 1 pixel increments.

When the number of pixels B below the threshold value is less than 50% of the total row pixel count (step S303 returns yes), that height C is set as the border height (step S305). This process is applied to the image data from both front and back sides to determine the respective border heights. The area comparison unit 23 then compares the two heights, and sets the higher value as the top border of the check 2 image area (step S306). The area above this top border is used as the masking area.

By thus also considering horizontal rows when identifying the media area, the likelihood of mistakenly identifying the media area and non-media area can be reduced even when, for example, a piece of paper is stuck on the scanning surface of the scanners 4, 5 or there is a high reflectivity material near the scanning surface of the scanners 4, 5.

### Other Embodiments

A check is used by way of example as the scanned medium in the embodiment described above, but other types of media, including various types of forms and sheet media, can be used.

Furthermore, the above embodiment has been described as having an image data processing apparatus and print head, but the invention could also be configured with a magnetic ink character reader (MICR) or other media processing device. Contrary an image data processing apparatus can be used separately (singly).

Furthermore, the image data processing apparatus is disposed to a media reader (check processing apparatus) comprising a scanner in the above-described embodiment, but it could be disposed on the host computer side. More specifically, the image data processing apparatus of this invention can be comprised to process image data acquired from a peripheral device that has a scanner, rather than the image data processing apparatus itself having a scanner. For example, the function of the image data processing apparatus described above can be incorporated into a device driver (program) for controlling a check processing apparatus, or an application program that uses the check processing apparatus.

The function of this image data processing apparatus is preferably built in to a device driver because this reduces the load on the check processing apparatus and the application program using the check processing apparatus, and device drivers can be easily updated. In such an embodiment the check processing apparatus sends image data captured from both sides of the medium by the scanners to the device driver. The device driver then identifies the media area and non-media area, removes unnecessary data from the image data, and sends the image data from which the unnecessary image data has been removed to the higher application program. The application program can then use the image data.

Furthermore, while unnecessary image data is deleted from the acquired image data, the masking area could be determined after reading part of the total image, and image data could then be captured from the area left after removing data in the masking area. This saves time in the scanning and image processing operations.

For example, the masking area could be set after scanning one-third of the front or back of the medium. After the masking area is set, only image data from the front and back that is within the area left after removing data in the masking area is then scanned and saved.

In another embodiment, the front and back of the medium could be prescanned to set the masking area. A final scan then controls scanning to image only the area that is left in the scanning area, that is, the image data area not including the masking area. The time needed to set the masking area in the prescan can be reduced by scanning and sampling the image data at a predefined interval, and using this sampled data to set the masking area. Furthermore, because the final scan then only images the area not including the masking area, less time is required for the final scan and image processing.

Using the check processing apparatus 1 shown in FIG. 1 by way of example, the front and back of the check 2 are prescanned by the scanners 4, 5 while conveying the check 2 through the transportation path 3, and the masking area is set. The check 2 is then conveyed in the opposite direction for the final scan, or the check 2 is returned to before the first scanner 4 and then conveyed in the normal forward direction for the final scan.

Furthermore, if the check processing apparatus has a form reversing mechanism, both sides of the check could be imaged using a single scanner.

If the check processing apparatus does not have a form reversing mechanism, the operator could manually reverse and reinsert the check so that the check is scanned twice by one scanner to image both sides of the check.

Furthermore, the process for discriminating the media area and non-media area can also be applied to the length and width dimensions of the scanned medium if the scanner is a flat bed scanner.

As described above, the image data processing apparatus and image data processing method of the present invention use image data captured from both sides of a scanned medium to identify the area in the image data where the scanned medium is present (the media area) and the area in the image data where the scanned medium is not present (the non-media area), and set the masking area based on the identified media area and non-media area. The present invention can therefore reduce the danger of necessary image data being masked or removed.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

1. An image data processing apparatus for processing image data captured by at least one scanner from both the back and front sides of a scanned medium, said image data processing apparatus comprising:
an area discrimination unit for identifying a media area in which the scanned medium is present and a non-media area in which the scanned medium is not present in the image data on both the front and back sides of the scanned medium;
an area comparison unit for comparing the size of the non-media area on the front side and the non-media area on the back side of the scanned medium respectively with said comparison unit defining the smaller non-media area as a masking area; and
a cropping control unit for generating image data from the image data on the front side and/or from the image data on the back side thereof not containing image data in the masking area.

2. The apparatus of claim 1, further comprising an image data transmission unit for sending to an external unit image data from which image data in the masking area has been removed.

3. The apparatus of claim 1, wherein at least one scanner is installed on both sides of a transportation path through which the scanned medium is conveyed.

4. The apparatus of claim 1, wherein the scanner captures image data of a conveyed scanned medium; and
the area discrimination unit obtains a border position between the media area and non-media area for vertical columns in the image data, and discriminates the media area and non-media area on each side of the scanned medium based on these border positions;
wherein the vertical direction is perpendicular to the transportation direction of the scanned medium.

5. The apparatus of claim 4, wherein the area discrimination unit obtains the border position for vertical columns sampled at a predefined interval.

6. The apparatus of claim 4, wherein the area discrimination unit obtains the ratio between a pixel count in the media area and a pixel count in the non-media area for horizontal rows in the image data, and identifies the media area and non-media area based on said ratio,
wherein said horizontal direction is parallel to the transportation direction of the scanned medium.

7. The apparatus of claim 1, wherein the area discrimination unit compares reflectivity in the image data and a specific threshold value, for identifying the media area from the non-media area.

8. The apparatus of claim 7, wherein the area discrimination unit comprises a threshold value calculation unit for determining a threshold value using a histogram generated by applying an averaging process to a frequency distribution of image data reflectivity values.

9. The apparatus of claim 1, wherein the area comparison unit defines a masking area when the scanner reads part of the front or back image data, and the scanner reads only image data from the area not including the masking area after the masking area is defined.

10. The apparatus of claim 1, wherein the scanner executes a prescan operation capturing front and back image data at a predefined interval, and after the area comparison unit defines the masking area, the scanner executes a final scanning operation capturing image data from the area not including the masking area.

11. An image data processing method comprising:
(a) acquiring image data from both the front side and the back side of a scanned medium;
(b) identifying a media area in which the scanned medium is present and a non-media area in which the scanned medium is not present in the image data of the front and back sides of the scanned medium;
(c) comparing the size of the non-media area of the front side with the non-media area of the back side, and defining the smaller non-media area as a masking area; and
(d) saving image data from the front image data and/or back image data not containing image data in the masking area.

12. The method of claim 11, further comprising:
(e) sending to an external unit image data from which image data in the masking area has been removed.

13. The method of claim 11, wherein step (a) captures image data by means of a scanner while the scanned medium is conveyed; and
step (b) obtains a border position between the media area and non-media area for vertical columns in the image data, and discriminates the media area and non-media area on each side of the scanned medium;
wherein the vertical direction is perpendicular to the transportation direction of the scanned medium.

14. The method of claim 13, wherein step (b) obtains the border position for vertical columns sampled at a predefined interval.

15. The method of claim 13, wherein step (b) further obtains the ratio between a pixel count in the media area and a pixel count in the non-media area for horizontal rows in the image data, and identifies the media area and non-media area based on said ratio,
wherein said horizontal direction is parallel to the transportation direction of the scanned medium.

16. The method of claim 11, wherein step (b) compares reflectivity in the image data and a specific threshold value, and identifies the media area and non-media area.

17. The method of claim 16, wherein step (b) determines a threshold value using a histogram generated by applying an averaging process to a frequency distribution of image data reflectivity values.

18. The method of claim 11, wherein a masking area is defined when part of the front or back image data is captured, and scanning image data from only the area not including the masking area.

19. The method of claim 11, further comprising the steps of performing a prescan operation for capturing front and back image data at predefined intervals for defining said masking area, and performing a final scanning operation for capturing image data from the area not including the masking area.

20. A data recording medium for storing a device driver program adapted to operate on a host computer to which a peripheral device having a scanner is connected, said device driver program executing an image data processing method in response to image data captured by said scanner from the front and back sides of a scanned medium while being moved under the control of said host computer, said image data processing method comprising steps of:
(a) receiving from the peripheral device image data from both the front and back sides of said scanned medium;
(b) identifying a media area in which the scanned medium is present and a non-media area in which the scanned medium is not present from the image data of the front and back sides of the scanned medium;
(c) comparing the size of the non-media area of the front side and the non-media area of the back side, and defining the smaller non-media area as a masking area; and
(d) generating image data from the front image data and/or back image data not containing image data in the masking area;
